(19) United States
(12) Patent Application Publication
(10) Pub. No.: US 2003/0149639 A1
(43) Pub. Date: Aug. 7, 2003

(54) Systems and methods for providing and accessing advice over a network

(76) Inventors: George D. Stolakis, York, PA (US); Jeff Robertson, York, PA (US)

Correspondence Address: BIRCH STEWART KOLASCH & BIRCH, PO BOX 747, FALLS CHURCH, VA, 22040-0747, US

(21) Appl. No.: 10/348,186

(22) Filed: Jan. 22, 2003

Related U.S. Application Data
(60) Provisional application No. 60/349,400, filed on Jan. 22, 2002.

(51) Int. Cl. G06F 17/60

(52) U.S. Cl. 705/26; 705/10

(57) ABSTRACT

The present invention relates generally to systems and methods for marketing products where the products are part of a product family having application dependent uses and where substantially improved product performance occurs when the product is properly selected for a given application. The systems and methods include offering the products in the product family to users and providing a web site to aid users in selecting the correct product. Additionally, the systems and methods include receiving a solicitation for advice at a web site to select the proper product for a given application from a client computer, processing the solicitation for advice, formulating advice selecting a preferred product based on the processing, and providing advice on the preferred product to the client computer.

### DESCRIPTION OF THE INVENTION

I. Field of the Invention

This invention relates generally to electronic commerce, and more specifically, to systems and methods for providing advice over a network relating to a problem.

II. Background of the Invention

As the popularity of the Internet has increased over the past decade, more consumers are utilizing the Internet for a variety of purposes. For example, consumers are using the Internet to access information and purchase goods. In considering goods that a consumer wishes to purchase, web sites that are accessed by the consumer generally contain a list of goods offered by the web site, together with a set of specifications about the goods. However, if the consumer wishes to seek additional information about the goods, the consumer with either need to physically go to the brick-and-mortar store or contact a person by telephone to solicit advice about a particular good. This is time consuming and costly.

If a consumer is looking for information regarding a particular problem to solve, the consumer would try to locate information on web sites. This information is typically in the form of articles and other types of published information. The consumer would potentially have to read numerous articles or other types of publications in the hopes of finding one written with the consumer's problem as the main issue. Again, this is time consuming and costly.

Additionally, there are situations where consumers have a specific problem and need advice on what product would solve the problem. For example, a consumer may have two pieces of a specific type of material that they were trying to splice together, and the type of adhesive was important in order to successfully splice the two together. If the incorrect adhesive was selected and used, the splicing would fail. Currently, consumers have to physically go to a consultant and show then the types of material wherein the consultant would suggest a solution. If the consumer were to attempt to solve the problem using information on the Internet, as stated above, the solution the consumer would choose is likely to fail.

As a result, there is a need for a system or method which allows a consumer, or user, to solicit advice regarding a particular problem over the Internet, thus providing convenience and saving the consumer's time and money in easily locating a solution.

### SUMMARY OF THE INVENTION

In accordance with the principles of the present invention, as embodied and broadly described herein, methods and systems consistent with the principles of the invention provide for marketing products wherein the products are part of a product family having application dependent uses and wherein substantially improved product performance occurs when the product is properly selected for a given application. The systems and methods include offering the products in the product family to users; providing a web site to aid users in selecting the correct product; receiving a solicitation for advice at a web site to select the proper product for a given application from a client computer; processing the solicitation for advice; formulating advice selecting a preferred product based on the processing; and providing advice on the preferred product to the client computer.

Additional features and aspects of the invention will be set forth in part in the description which follows, and in part will be obvious from the description, or may be learned by practice of the invention. The features and aspects of the invention will be realized and attained by means of the elements and combinations particularly pointed out in the appended claims.

### BRIEF DESCRIPTION OF THE DRAWINGS

The accompanying drawings, which are incorporated in and constitute a part of this specification, illustrate several embodiments of the invention and together with the description, serve to explain the principles of the invention, and, together with the description, explain the features and aspects of the invention. In the drawings,

FIG. 1 is an exemplary diagram of a system environment in which systems and methods, consistent with the principles of the present invention, can be implemented;

FIG. 2 is an exemplary diagram of the main components of a client computer, consistent with the principles of the present invention;

FIG. 3 is an exemplary diagram of the main components of a server computer, consistent with the principles of the present invention;

FIG. 4 depicts an exemplary diagram of the main components of an administrative server, consistent with the principles of the present invention;

FIG. 5 depicts an exemplary flow chart of the steps performed by a client computer in soliciting advice regarding a paper-splicing query on a web site, consistent with the principles of the present invention;

FIG. 6 depicts an exemplary flow chart of the steps performed by a server computer in receiving queries and providing advice on a network, consistent with the principles of the present invention;

FIG. 7 depicts an exemplary flow diagram of the steps performed by a server computer in receiving queries and providing advice by establishing a video connection, consistent with the principles of the present invention;

FIG. 8 depicts an exemplary flow chart of the steps performed by a server computer in providing information relating to a sample that has been tested, consistent with the principles of the present invention;

FIG. 9 depicts an exemplary diagram of a screen shot presented to a user including an interactive map as it may appear on a web site, consistent with the principles of the present invention; and

FIG. 9A depicts an exemplary flow diagram of the steps performed by a server computer is provided an interactive map, consistent with the principles of the present invention.

### DESCRIPTION OF THE EMBODIMENTS

Reference will now be made in detail to the present invention, examples of which are illustrated in the accompanying drawings. Wherever possible, the same reference numbers will be used throughout the drawings to refer to the same or like parts.

Overview

Methods and systems consistent with the principles of the present invention provide for allowing a user, through a client computer, to access a server through a network. The user, through the client computer, can submit a query regarding a problem relating to paper splicing, fiber-glass splicing, textile splicing, film splicing, non-woven splicing, etc. This query may further relate to any material that is in web form and/or any material that is manufactured in rolls. The information relating to the problem is received by the server and processed. Processing may be done solely by the server computer, which may include other communicably linked resources, by a combination of the server computer and a consultant, or solely a consultant. A solution, including advice on how to solve the problem may then be submitted to the user.

It can be appreciated that the query may relate to any type of problem, for example, selecting a material for splicing, for example, adhesives, tapes, etc., selecting printing ink for printing on a particular type of paper, or selecting metals for a particular type of cast. For exemplary purposes, the problem for discussion with respect to the following disclosure relates to paper splicing.

System Architecture

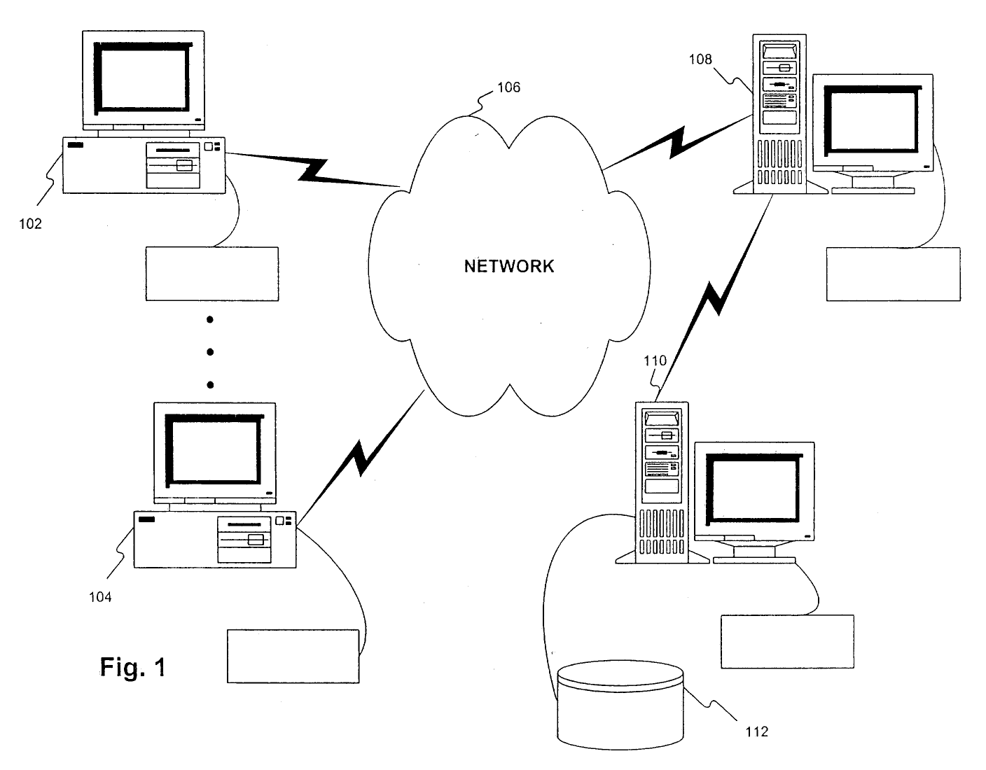

FIG. 1 is an exemplary diagram of a system environment 100 for implementing the principles of the present invention. The components of system 100 can be implemented through any suitable combinations of hardware, software, and/or firmware. As shown in FIG. 1, system 100 includes a plurality of client computers 102 and 104, network 106, server computer 108, administrative server 110 and database 112. While only two client computers are shown, it can be appreciated that any number of client computers may reside on network 106. Client computers 102 and 104 may access server 108 via network 108 through an associated Internet Service Provider (not shown). While network 106 may preferably be implemented as the Internet, network 106 may be any local or wide area network, either public or private.

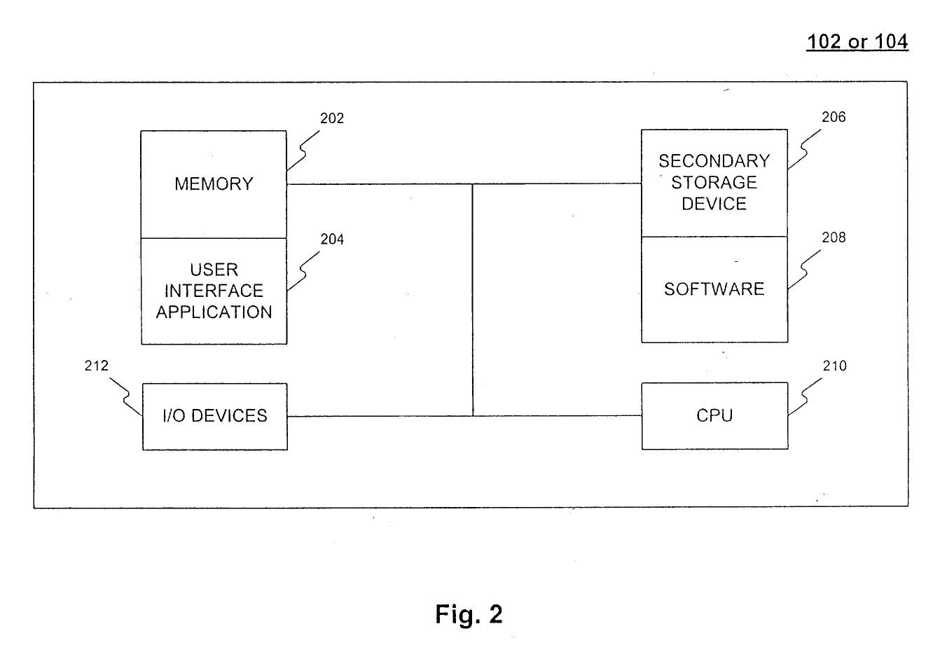

FIG. 2 depicts an exemplary block diagram of components contained in client computers 102 and 104. Client computers 102 and 104 may be of any type of computing device, such as a personal computer or workstation, and may, for example, contain memory 202, browser software 204, secondary storage 206, software 208, central processing unit (CPU)210 and input/output (I/O)devices 212. A user can access network 106 using browser software 204. Browser 204 may comprise a conventional browser application, including conventional browser applications available from Microsoft or Netscape.

Input/output devices 212 may include, for example, a keyboard, a mouse, a video cam, a display, a storage device, and/or a printer. User interface 204 may be implemented as a conventional browser application, including conventional browser applications available from Microsoft or Netscape. A user can launch user interface 204 through input/output devices 212 and access server 108 through network 106. Address database 208 may be implemented as a conventional database application and can be used for storing address information temporarily while accessing server 108. It can be appreciated that address database 208 may reside at server 108.

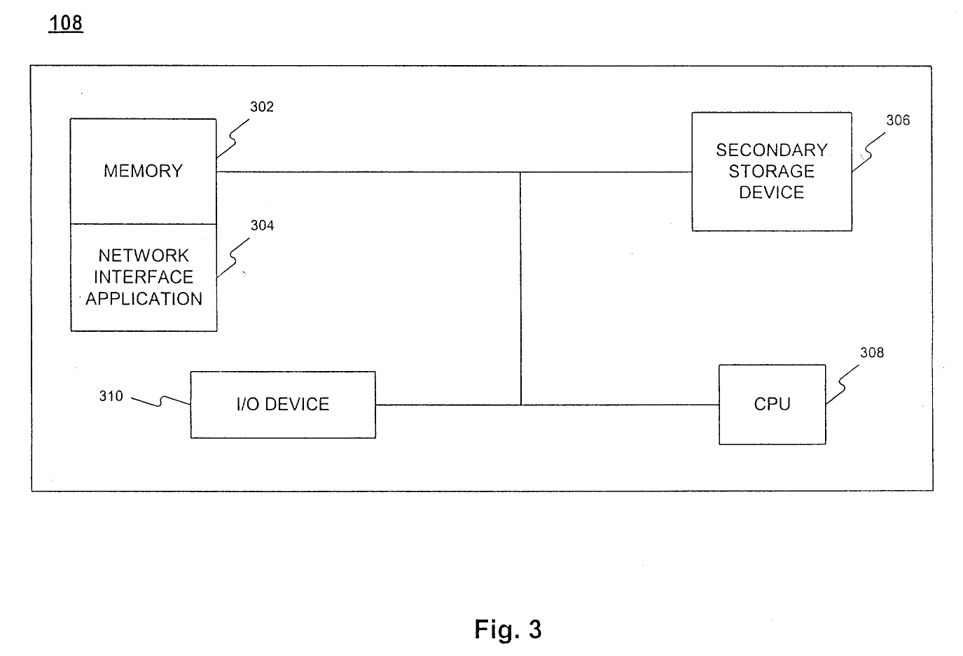

FIG. 3 depicts an exemplary diagram of server 108 that may be implemented in system environment 100, consistent with the principles of the present invention. As shown in FIG. 3, server 108 includes a memory 302, a network interface application 304, a secondary storage device 306, a CPU 308 and input/output devices 3 10. Input/output devices 212 may include, for example, a keyboard, a mouse, a video cam, a display, a storage device, and/or a printer. Server 108 is connected to network 106 and may be communicably linked with client computers 102 and 104 for accessing and submitting information at a web site through network interface application 304. Server 108 may further be communicably linked to administrative server 110.

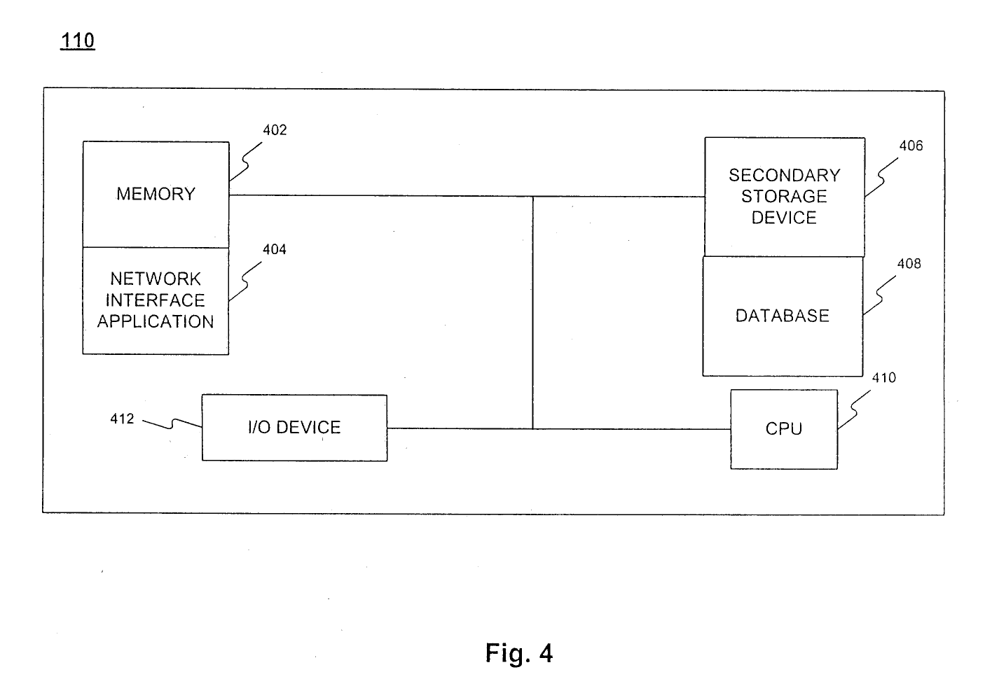

FIG. 4 depicts an exemplary diagram of administrative server 10 that may be implemented in system environment 100, consistent with the principles of the present invention. As shown in FIG. 4, administrative server 110 includes a memory 402, a secondary storage 406, a database 408, a CPU 410 and input/output devices 410. Administrative server 110 is communicably linked to server 108. Database 408 or database 112 may be implemented as a conventional database application and can be used for storing information relating to paper splicing inquiries. It can be appreciated by one of ordinary skill in the art that the information contained in database 408 or 112 may be stored in secondary storage device 406 or secondary storage device 306.

Implementation

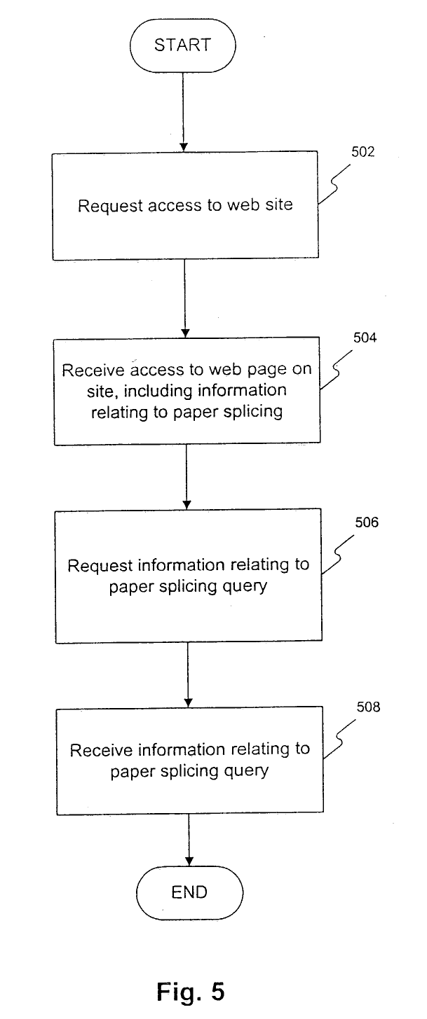

FIG. 5 depicts an exemplary flow chart of the steps performed by a client computer in accessing and submitting information on a web site consistent with the principles of the present invention. As shown in FIG. 5, client computer 102 or 104, through user interface application 204, requests access to the web site located at server 108 through network 106 (Step 502). Client computer 102 or 104 receives access to the web site, which includes information and access to advice regarding paper splicing issues (Step 504).

Client computer 102 or 104 may then request access to information relating to a paper-splicing query (Step 506). The may be done in a number of ways. For example, a user may view information provided on the web site; may view additional information provided on the web site, including accessing additional information through a menu that is provided; may establish a direct connection with a person located at server 108, i. e., via a video connection or web cam; may submit an e-mail including the query; may mail information relating to the query, i. e., a sample to be tested, and requesting information regarding the sample; etc. The user may provide to the consultant at server 108 the particular type of materials the user is attempting to splice. Additional information may be specified in an attempt to find a successful solution to the user's problem, where only a limited number of solutions may be available. After the user submits information relating to a paper-splicing query, the user may then receive a response including advice and information responding to the paper-splicing query (Step 508).

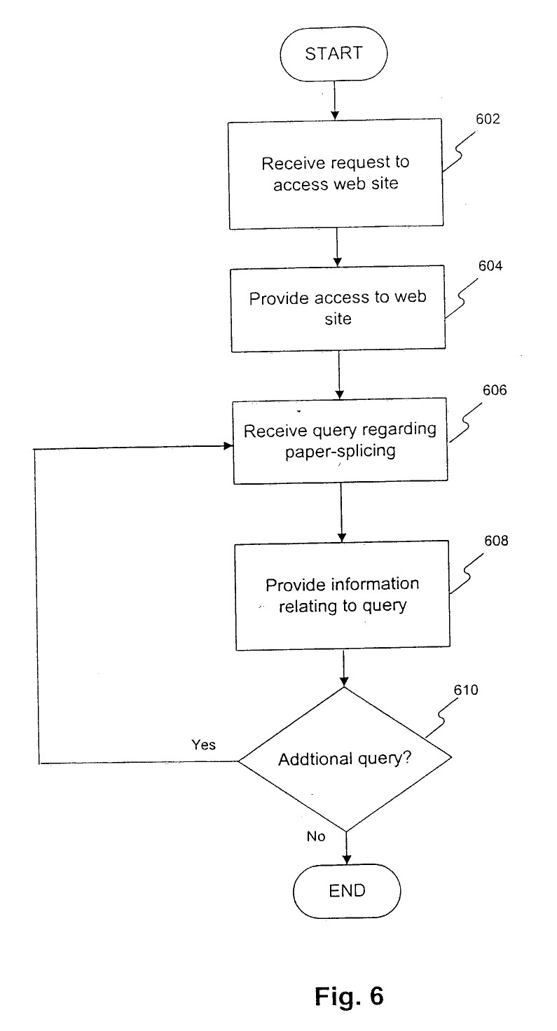

Server computer 108 can be accessed by client computers 102 and 104 through network 106. Additionally, server 108 can communicate with administrative server 110. Server computer 108 maintains a web site including information relating various issues relating to paper splicing. FIG. 6 depicts an exemplary flow chart of the steps performed by a server computer in providing information and receiving queries on a network, consistent with the principles of the present invention. Server 108, while providing information relating to various paper splicing issues on a web site, may receive a request from client computer 102 or 104 to access the web site (Step 602). Server computer 108 may provide access to the web site (Step 604). Server computer may receive a query including information relating to a problem involving paper splicing (Step 606). For example, the query may include the types of paper to be spliced, etc. Server computer 108 responds to the query by providing information solving the problem submitted by client computers 102 or 104 (Step 608). For example, the information sent by server 108 may include the proper type of adhesive to be used in splicing the type of paper specified by the user. If there is an addition query for information by the user, processing returns to Step 606.

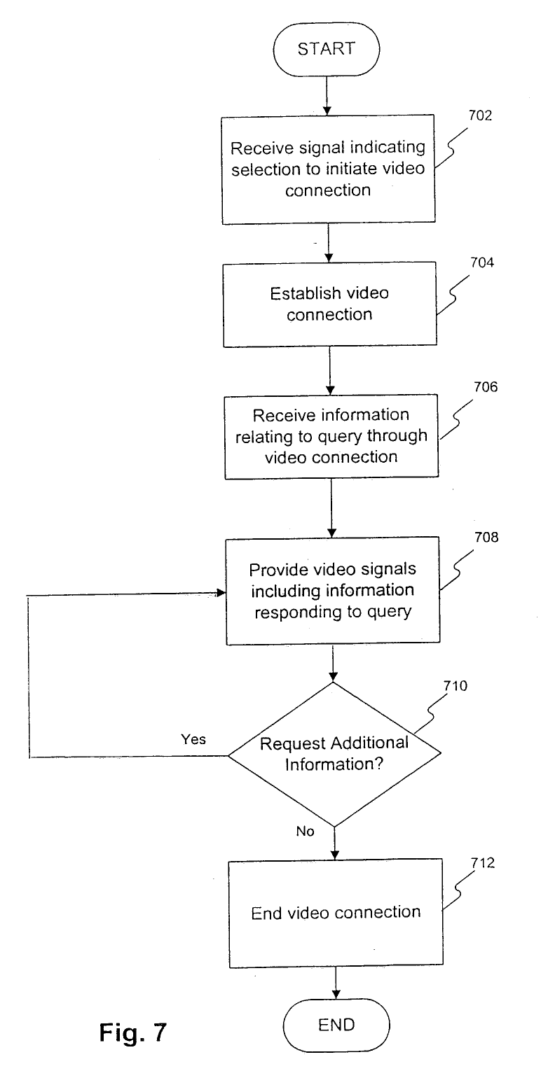

As stated above, there are various ways that information can be transferred between client computers 102 and 104 and server computer 108. For example, a user, through client computer 102 or 104 may choose to establish a video connection to show to a consultant on the server side what the problem to be solved is. FIG. 7 depicts an exemplary flow diagram of the steps performed by a server computer 108 in providing information to client computer 102 or 104 by establishing a video connection consistent with the principles of the present invention.

As shown in FIG. 7, server computer 108 receives a signal from client computer 102 or 104 indicating the user wishes to establish a video connection (Step 702). Using conventional web cam technology, or other suitable means, server computer 108 establishes a video connection with client computer 102 or 104 (Step 704). A consultant, through the established video connection then receives information relating to a problem that a user has regarding a paper splicing problem (Step 706). For example, the user can demonstrate what the particular problem is, what types of material are being used, etc. In response to the information that is received from the user through the established video connection, a consultant, through server 108, can respond to the query submitted by the user (Step 708). For example, the consultant can demonstrate how to solve the problem by actually demonstrating the solution to the user. If there are additional queries from the user, (Step 710, Yes), then processing returns to Step 708. If there are no additional queries from the user (Step 710, No), then the video connection is disconnected (Step 712).

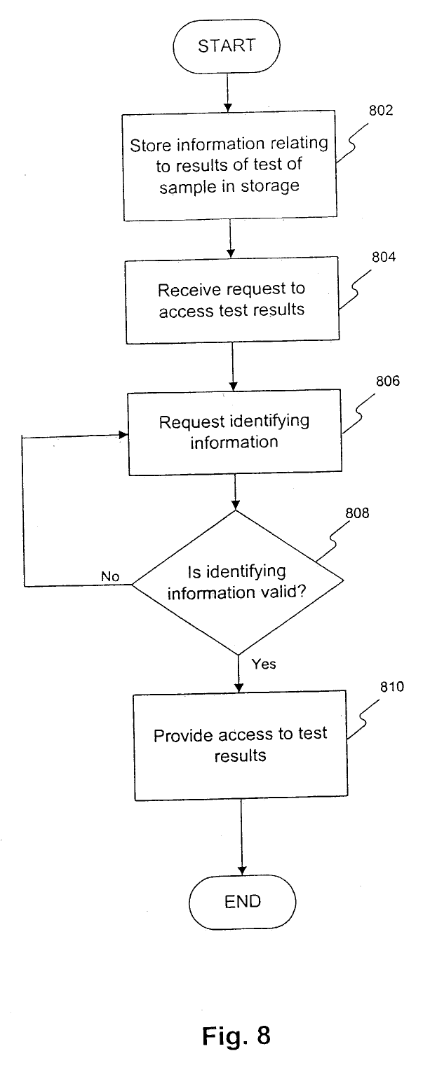

As stated above, another way a user can request information is by mailing a sample to a company hosting a web site on network 106 and requesting information regarding the sample to be tested. FIG. 8 depicts an exemplary flow chart of the steps performed by a server computer 108 in providing information relating to a sample that has been tested, consistent with the principles of the present invention. Once the company has performed the testing on the sample submitted by the user, the data relating to the testing information, including any additional information provided by the consultant, may be stored in a database 112, (Step 802). It can be appreciated by one of ordinary skill in the art that this information may alternatively be stored in database 408 in administrative server 110 or secondary storage 306. Preferably, this information is not stored on server computer 108 for security purposes.

Server computer may receive a request from client computer 102 or 104 to access to the test results through the web site on server computer 108 (Step 804). In response to this request, server computer 108 may request identifying information (Step 806). This information may be in the form of, for example, a user identification number, a password, a sample number, etc. After the user, through client computer 102 or 104 submits the identifying information, server computer 108 verifies that the information is valid. If the information is invalid (Step 808, No), then processing returns to Step 806 for server computer 108 to prompt the user for valid identifying information. If the identification is valid (Step 808, Yes), then access is provided to the test results (Step 810). After the user views the test results, server computer 108 allows the user to request additional information through any method set forth herein.

Alternatively, database 112 may include information relating to various issues relating to paper splicing. Upon a user accessing a web site, he may be able to submit a query to server 108, which would then search database 112 using the submitted query. The query may take the form of a key word search, a question in the form of a sentence, or any other type of conventional search. Once the database has been searched, the results of the query may be optionally formatted, optionally sorted, and submitted to the user for review.

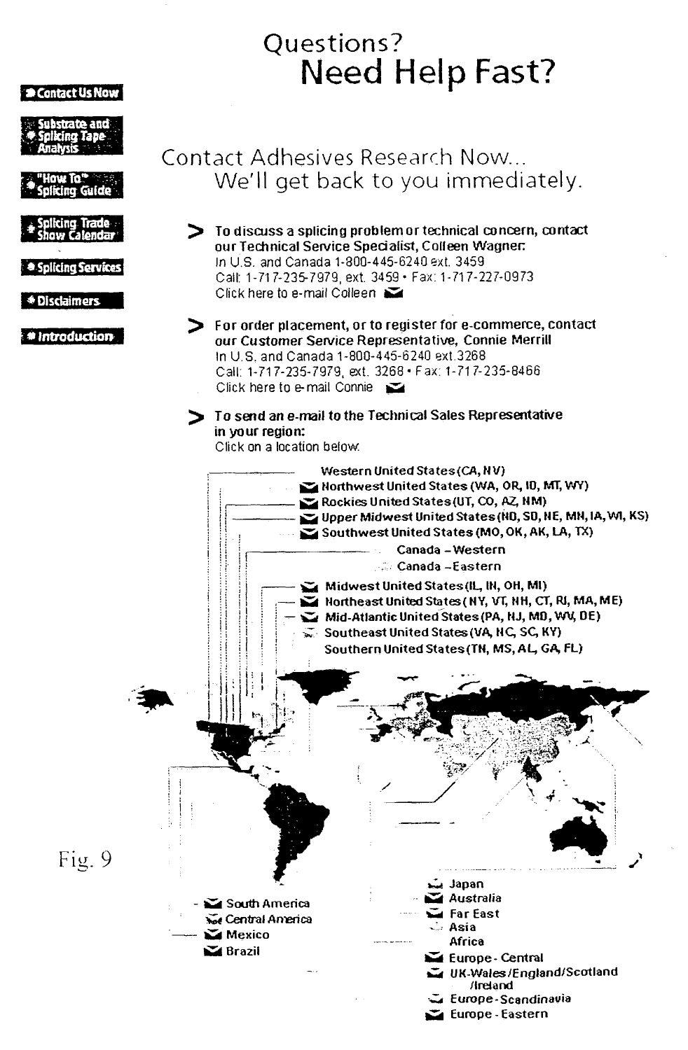

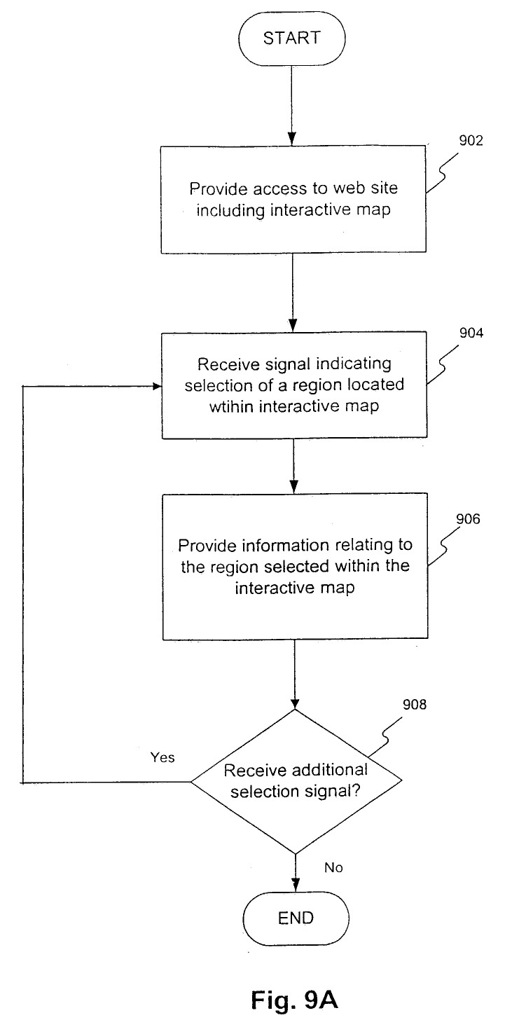

Another feature that may be provided at the web site hosted by server computer 108 is an interactive map. This interactive map allows a user to access information relating to a particular geographic region. An exemplary diagram of a screen shot presented to a user including an interactive map as it may appear on the web site, consistent with the principles of the present invention is depicted in FIG. 9.

As shown in FIG. 9, contact information is provided to the user depending upon the type of information the user is looking for, i. e., to discuss a splicing problem or technical concern, to place an order, etc. Additionally, FIG. 9 shows a color-coded map of the world, wherein the each country has an e-mail contact. Further, the United States contains additional regions containing contacts depending upon where the user is located within the United States. While e-mail connections are indicated in FIG. 9, it may be appreciated by one of ordinary skill in the art that direct connections, including video cam connections, may be made. Further, additional information may be provided to the user, including contact name, address, telephone number, e-mail address, etc.

FIG. 9A depicts an exemplary flow diagram of the steps performed by a server computer in provided an interactive map, consistent with the principles of the present invention. Once a user accesses the web site, server computer 108 provides access to an interactive map (Step 902). This interactive map may be divided into region by numerous ways. For example, the map may be divided by countries, by states or provinces within a country, by counties within states, etc. In addition, if the map is, for example, divided by countries, once a user selects a particular country (Step 904) a new map may be presented to the user depicting the selected country divided into, for example, states. Once the user selects a particular state, the selected state may be divided into counties, etc. Ultimately, the user may be provided with information relating to the particular location selected by the user (Step 906). This information may include a local consultant's contact information, which may name, telephone number, business address, e-mail address, prompt for video cam connection, schedule an appointment with a local consultant, etc.

Another method allowing a user to solicit advice regarding a paper splicing problem is by hosting a trade show or conference over network 106. This may be accomplished through any suitable means, including Microsoft's NetMeeting 0, First Virtual Communications' CuseeMe, Cybration Inc's ICUII, etc. Through the video connection, the user has the opportunity to view the activities at a trade show without being physically present. In addition, the user has the opportunity to interact with consultants at the trade show in order to solicit advice about paper splicing generally, or with regard to specific paper splicing problems. Since the communication may be bi-directional the user may have the opportunity to show the consultant a particular problem, as stated above in the discussion of the video cam connection.

Another method for allowing a user to solicit advice regarding a paper splicing problem is by sending a user an announcement regarding a new product that is being introduced. This may be accomplished through e-mail to all users, or through any other suitable means. Once the user received the announcement regarding the new product, the user may then solicit information and/or advice regarding the new product through methods disclosed herein, including participating in the trade show over network 106, utilizing the interactive map to locate a local consultant, sending an e-mail to request additional information, establishing a video cam connection with a consultant to discuss the new product, etc. It can be appreciated by one of ordinary skill in the art that the e-mail may contain additional information regarding the new product. The e-mail may further notify the user that a sample of the new product is being sent.

It can be appreciated by one of ordinary skill in the art that the web site hosted on server 108 may additionally provide products for sale in response to the solutions provided by the consultant. Further, the web site may include links to distributors of products relating to paper splicing.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone.

Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

What is claimed is:

1. A method of marketing products wherein the products are part of a product family having application dependent uses and wherein substantially improved product performance occurs when the product is properly selected for a given application, the method comprising:
offering the products in the product family to users;
providing a web site to aid users in selecting the correct product;
receiving a solicitation for advice at a web site to select the proper product for a given application from a client computer;
processing the solicitation for advice;
formulating advice selecting a preferred product based on the processing; and
providing advice on the preferred product to the client computer.

2. The method of claim 1, wherein satisfactory product performance is available only when the correct product is selected.

3. The method of claim 1, wherein the advice provided relates to at least one of paper splicing, fiber-glass splicing, textile splicing, film splicing, splicing materials that may be in web-form, and splicing materials that are manufactured in rolls.

4. The method of claim 1, wherein receiving the solicitation for advice includes:
receiving an indication of a geographic location; and
including in the advice information related to the geographic location.

5. The method of claim 1, wherein receiving the solicitation further includes receiving information regarding a sample to be tested.

6. The method of claim 1, wherein the advice provided includes information regarding a type of adhesive that may be successfully used in splicing.

7. A system for marketing products wherein the products are part of a product family having application dependent uses and wherein substantially improved product performance occurs when the product is properly selected for a given application, comprising:
a memory storing program instructions; and
a processor configured to respond to the instructions to offer the products in the product family to users;
provide a web site to aid users in selecting the correct product;
receive a solicitation for advice at a web site to select the proper product for a given application from a client computer;
process the solicitation for advice;
formulate advice selecting a preferred product based on the processing; and
provide advice on the preferred product to the client computer.

8. The system of claim 7, wherein satisfactory product performance is available only when the correct product is selected.

9. The system of claim 7, wherein the advice provided relates to at least one of paper splicing, fiber-glass splicing, textile splicing, film splicing, splicing materials that may be in web-form, and splicing materials that are manufactured in rolls.

10. The system of claim 7, wherein the processor is further configured to:
receive an indication of a geographic location; and
include in the advice information related to the geographic location.

11. The system of claim 7, wherein the processor is further configured to receive information regarding a sample to be tested.

12. The system of claim 7, wherein the advice provided includes information regarding a type of adhesive that may be successfully used in splicing.

13. A computer-readable medium containing instructions, executed by a processor, for performing a method of marketing products wherein the products are part of a product family having application dependent uses and wherein substantially improved product performance occurs when the product is properly selected for a given application, the method comprising:
offering the products in the product family to users;
providing a web site to aid users in selecting the correct product;
receiving a solicitation for advice at a web site to select the proper product for a given application from a client computer;
processing the solicitation for advice;
formulating advice selecting a preferred product based on the processing; and
providing advice on the preferred product to the client computer.

14. The computer-readable medium of claim 13, wherein satisfactory product performance is available only when the correct product is selected.

15. The computer-readable medium of claim 13, wherein the advice provided relates to at least one of paper splicing, fiber-glass splicing, textile splicing, film splicing, splicing materials that may be in web-form, and splicing materials that are manufactured in rolls.

16. The computer-readable medium of claim 13, wherein receiving the solicitation for advice includes:
receiving an indication of a geographic location; and
including in the advice information related to the geographic location.

17. The computer-readable medium of claim 13, wherein receiving the solicitation further includes receiving information regarding a sample to be tested.

18. The computer-readable medium of claim 13, wherein the advice provided includes information regarding a type of adhesive that may be successfully used in splicing.
